(19) United States
(12) Patent Application Publication
(10) Pub. No.: US 2024/0170996 A1
(43) Pub. Date: May 23, 2024

(54) AUTONOMOUS ELECTRICAL SUPPLY DEVICE, IN PARTICULAR FOR CHARGING A BATTERY

(71) Applicant: ATEQ, Les Clayes-sous-Bois (FR)

(72) Inventor: Jacques Mouchet, Les Clayes-sous-Bois (FR)

(21) Appl. No.: 18/283,437

(22) PCT Filed: Mar. 24, 2022
(86) PCT No.: PCT/EP2022/057765

§ 371 Date: Sep. 21, 2023

(30) Foreign Application Priority Data
Mar. 24, 2021 (FR) 2102967

(51) Int. Cl. H02J 7/34; B60L 53/16; B60L 53/302; B60L 53/53; B60L 53/60; H02J 1/10; H02J 7/00

(52) U.S. Cl. CPC H02J 7/342; B60L 53/16; B60L 53/302; B60L 53/53; B60L 53/60; H02J 1/122; H02J 7/0042; H02J 7/0068; H02J 2207/20

(57) ABSTRACT

The present invention relates to a self-contained power supply device (1), for example for recharging a traction battery of a motor vehicle, characterised in that said device (1) comprises: an electric battery (3) comprising a control system (3a) for controlling storage batteries; a first and a second power converter (5 and 7); a first electrical socket (9) connected to said battery (3) via the first converter (5); a second electrical socket (11) connected to said battery (3) via the second converter (7); said battery (3) being configured to be charged via the first socket (9) and to recharge an external device via the second socket (11).

The present invention relates to the field of autonomous electrical supply devices for electrically charging appliances, such as a battery, and in particular a traction battery mounted in an electric or hydrogen vehicle (also designated respectively by the acronyms PEV and H2EV respectively).

Hydrogen vehicles and electric vehicles include an electric traction machine (or electric motor) that delivers a driving torque to the wheels of the vehicle, using energy stored in an assembly (hereinafter referred to as traction battery) comprising a series of electrical accumulators, which may be produced in accordance with various types of schemes, and which produce this energy from electrochemical reactions. Traction battery means here a battery supplying in particular electricity to the electric motor of a motor vehicle.

Traction batteries for vehicles are generally lithium-ion batteries that have a good compromise between weight and electrical storage capacity.

However, the driver of a vehicle including a traction battery may encounter certain problems. For example, the traction battery may be completely discharged following faulty management of the capacity of the battery by the driver (forgetting to charge the traction battery, too much presumption about residual range in the traction battery, etc.) or following prolonged non-use of the vehicle.

It is then necessary to have recourse to a tow truck to move the vehicle to the closest charging point and thus to recharge it.

This has the drawback of being expensive and time-consuming, all the more so when the charging point is remote from the place of breakdown, in particular in a rural area. In addition, a tow truck, because of its size, cannot always access some places, in particular in town, for example in an underground car park, to tow the vehicle to the most suitable place.

The same problem may also be posed for supplying equipment, tools, lighting means, etc in places without electrical supply sources.

Thus, the present invention proposes overcoming at least one of the aforementioned drawbacks and provides a novel type of autonomous electrical-supply device whether for recharging a traction battery of a vehicle or various other appliances. Such a device is preferably mobile.

The present invention is thus an autonomous electrical-supply device, comprising:
an electric battery including a system for controlling the batteries of accumulators;
a first electrical converter and a second electrical converter;
a first electric socket connected to said battery through the first converter;
a second electric socket connected to said battery through the second converter;
   said battery being configured on the one hand to be charged through the first socket and on the other hand to recharge, through the second socket, an external apparatus (the external appliance is for example a battery).

The device according to the invention is robust, economical to manufacture, easy to use and compact, thus making it possible to bring it easily to any place to electrically supply various types of appliances.

According to a possible feature of at least one embodiment of the invention, said device is configured to recharge, through the second socket, an electric battery, in particular a traction battery of a motor vehicle.

The device according to this embodiment finds a particularly advantageous application in electric-vehicle breakdown maintenance, among other things through being able to directly recharge the traction battery mounted in the motor vehicle.

According to another possible feature, the first converter is connected to the system controlling the batteries of accumulators of said battery, said system for controlling the batteries of accumulators regulating, through said first converter, the charging of said battery.

It is advantageous that the system for controlling the battery can regulate the charging, in order to avoid overheating and/or overcurrents that can damage said battery.

According to another possible feature, the device comprises a third converter configured to electrically supply the system for controlling the batteries of accumulators by means of said battery.

Said third converter is for example disposed inside the sleeve of the battery of the device.

The fact that the system for controlling the battery is supplied by the battery itself makes it possible in particular to reduce the manufacturing cost of the device according to the invention.

According to another possible feature, said device comprises at least one energy storage element configured to electrically supply said control system.

Said energy storage element is for example a battery, a supercapacitor or a combination of these elements, and is configured to temporarily supply one or more electronic components enabling the device to be started up without using the main battery.

Said energy storage element can advantageously be recharged during the charging or discharging by the battery of said device according to the invention.

According to another possible feature, the device comprises a voltmeter configured to measure the value of the voltage U_{BAT} of said battery.

Said voltmeter makes it possible in particular to check the state of charge of the battery of said device and to enable the user to know whether the battery is sufficiently charged to allow the recharging of a traction battery or whether it is necessary to recharge said battery. It should be noted that the visual indicator for indicating the state of charge of said battery may be one or more coloured indicator lights, bar graphs, screens or any combination of these means.

According to another possible feature, said device comprises at least one energy storage element configured to electrically supply said control system.

According to another possible feature, said device comprises thermal regulation means configured to regulate the temperature of the battery, of the first converter, of the second converter and/or of the third converter.

According to another possible feature, said thermal regulation means comprise heating means and/or cooling means configured respectively to heat/cool the battery, the first converter, the second converter and/or the third converter.

It is necessary to be able to regulate the temperature of the battery, since the latter may deteriorate very quickly if it operates at excessively low or excessively high temperatures (generally below −5° C. and above 35° C.)

According to another possible feature, the device comprises a human-machine interface.

It should be noted that human-machine interface means all the elements enabling the user to interact with the device according to the invention, more particularly to control the device according to the invention and to exchange information with said device.

According to another possible feature, the device comprises a first switch configured to enable or prevent the charging of the battery, and a second switch configured to enable or prevent the charging of a traction battery by the battery of said device.

According to another possible feature, the device according to the invention comprises at least two operating modes, mutually exclusive, able to be selected through the human-machine interface: a mode for charging said battery, and a mode for charging an external appliance, such as a traction battery.

According to another possible feature, the device according to the invention comprises a carriage provided with wheels.

The device is advantageously in the form of a carriage, thus facilitating manipulation thereof by a single operator.
In particular by making it possible to drag the device on ramps (example by making it possible to easily unload the device from a transport vehicle) or to convey it in an underground car park lift, on an upper floor, etc.

The invention also relates to a motor vehicle that includes a device as defined above, for example a vehicle comprising 2 to 4 wheels, such as a scooter or a motorcycle.

The invention will be better understood, and other aims, details, features and advantages thereof will appear more clearly throughout the following description of particular embodiments of the invention, given only for illustrative and non-limitative purposes, with reference to the accompanying drawings, wherein:

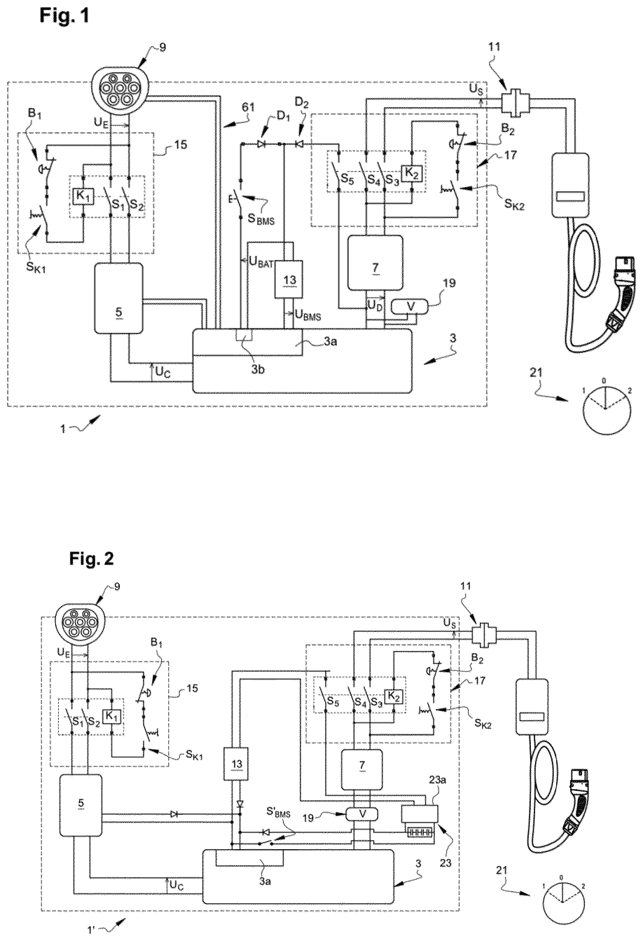

FIG. 1, referenced [FIG. 1], is a highly schematic representation of a first embodiment according to the invention of a mobile device for recharging an electric battery of a motor vehicle;

FIG. 2, referenced [FIG. 2], is a highly schematic representation of a variant embodiment of the device of FIG. 1;

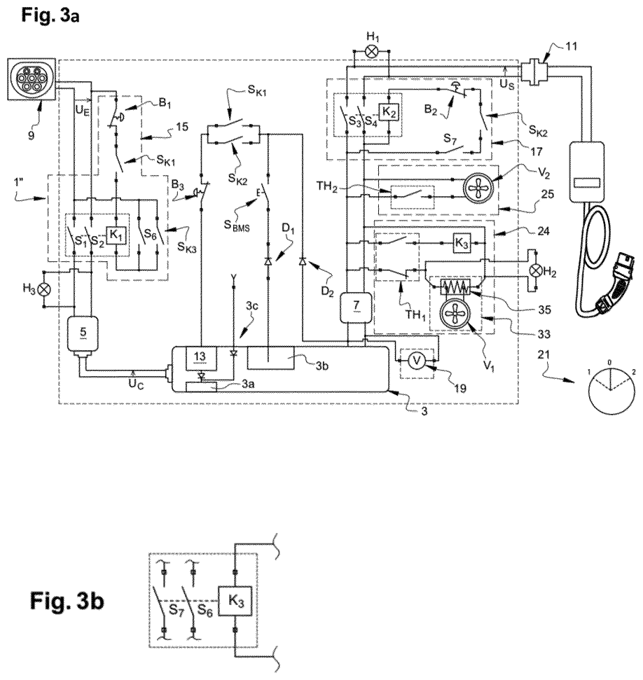

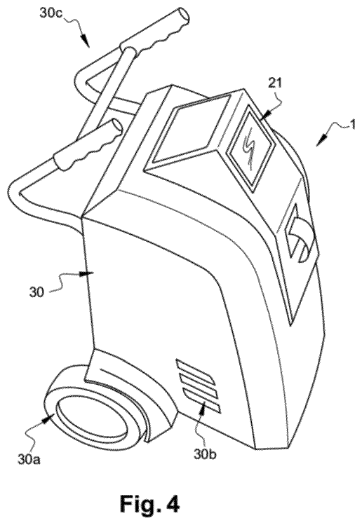

FIG. 3a, referenced [FIG. 3a], is a highly schematic representation of a second embodiment of the device according to the invention;

FIG. 3b, referenced [FIG. 3b], is a highly schematic and enlarged representation of a relay of the device of FIG. 3a;

FIG. 4, referenced [FIG. 4], is a perspective representation, seen from above, of one of the devices of FIGS. 1, 2 or 3a.

FIG. 1 is thus a highly schematic representation of a first embodiment according to the invention of a mobile device 1 for recharging a traction battery of a motor vehicle.

More particularly, said device 1 comprises:
an electric battery 3;
a system 3a for controlling the batteries of accumulators of said battery 3 (a control system also designated, in English, by the term “Battery Management System” and/or by the abbreviation “BMS”);
a first electrical converter 5;
a second electrical converter 7;
a first electrical socket 9 connected to said battery 3 through the first converter 5;
a second electrical socket 11 connected to said battery 3 through the second converter 7.
   This electric battery 3 is configured on the one hand to be charged through the first socket 9 and on the other hand to recharge, through the second socket 11, the traction battery of a motor vehicle, such as an electric or hydrogen vehicle.

Said battery 3 is for example a battery of the lithium-ion type (but other types of chemistry are also possible for said battery), in particular batteries having a capacity of between 2 and 10 kWh and having voltages of between 12 and 100 V. More particularly, said battery 3 is advantageously disposed in a sealed metal casing, for example made from aluminium, to promote the dissipation of heat (generated in the battery) during the charging or discharging of said battery 3.

By way of non-limitative example, the first converter 5 is configured to convert a so-called “input” or “charging” voltage U_{E}, coming from the first socket 9, into a DC voltage U_{C}, for example of 83 V, which is intended to charge said battery 3, which has a so-called “nominal” voltage, for example of 73 V. It is recommended that the charging voltage U_{C} be higher than the nominal voltage of the battery 3, in particular to optimise the charging (duration, heat dissipation, etc.) of said battery 3.

The voltage U_{E} coming from the first socket 9 comes for example from a connection to a current socket (for example domestic) or to a charger for an electric car.

Said first converter 5 is moreover connected to the control system 3a of said battery 3. Thus the charging of the battery 3 by the converter 5 is regulated by the control system 3a. It should be noted moreover that said control system 3a is here internal to the battery 3, but said system 3a may also be internal to the converter 5 or more generally be external to the battery 3.

It should also be noted that the electrical socket 9 may be electrically connected (actively or passively), through a connection 61, to the control system 3a, so as to enable the connection to be established between an electrical source, such as a standard electric car charger, and the device 1.

This control system 3a may be either autonomous or incorporated for example in the socket 9, the charger or any other element constituting the device. It should be noted that the control system 3a can also be defined as an electronic system enabling the control and charging of the various elements of a battery of accumulators.

Thus, when the socket 9 is connected to an electrical supply source, the control system 3a detects the connection of the source (subject to the source being adapted) and optionally configures the source and/or the battery 3 to favour the charging of the battery 3 by said connected supply source. Should the source to which the device 1 is connected, through the socket 9, not be compatible with a connection of this type with the control system 3a, the intensity of the charging current is limited, example to 8 amperes (it will thus be understood that the connection 61 is optional).

The second converter 7 for its part is a DC to AC converter, and therefore configured to convert the DC voltage U_{D} delivered by the battery 3 into an AC output voltage U_{S} for supplying the second socket 11. The second converter 7 is for example an inverter or a plurality of stackable inverters thus making it possible to easily vary the current that can be delivered at the output of said second converter 7 at the second socket 11.

Said device 1 furthermore optionally comprises a third converter 13 that connects said battery 3 to a permanent electrical output 3b of said battery 3, in order to electrically supply it. The third converter 13 is thus configured to convert the voltage U_{BAT} delivered by the battery 3 at the output 3b into a voltage U_{BMS}, for example between 5 and 12 V, intended to supply and operate the control system 3a. The third converter 13 is for example a DC to DC converter.

More particularly, in this embodiment, the electrical output 3b comprises two connectors, one identifying itself to the positive terminal of the battery 3 and the other to an earth, said two connectors being connected to the input of the third converter 13, through a switch S_{BMS}. This switch S_{BMS} is configured to switch and thus trigger or interrupt the electrical supply of the control system 3a of said battery 3.

Said third converter 13 is also connected to the battery 3 at the connection connecting the positive terminal of the battery 3 to the input of the second converter 7.

Moreover, a diode D₁ is advantageously disposed between the connector of the output 3b identifying itself to the positive terminal and the connection connecting the third converter 13 to the positive terminal of the battery 3. This diode D₁ makes it possible to limit any electrical problems, in particular excessively high current at the connector of the output 3b. A diode D₂ can also advantageously be disposed between the second converter 7 and third converter 13, this diode D₂ preventing in particular excessively high electrical currents going back from the connector 3b in the direction of the second converter 7.

The first and second sockets 9 and 11 are for example conventional current sockets (for example “AC” standing for “alternating current” in English) dependent on the country of use, or normal sockets for charging electric vehicles of the so-called type 1, type 2, “combos” or any other standard or future connection device for electric, hybrid or hydrogen vehicles. The second socket 11 is in particular configured so that equipment or an adapter for recharging the vehicle (in English “Electric Vehicle Service Equipment” or EVSE) can be connected thereto to electrically connect the device 1 to a traction battery requiring recharging, or to the vehicle requiring recharging of its traction battery.

Said device 1 advantageously comprises a voltmeter 19 configured to measure the value of the voltage of said battery 3. Said voltmeter 19 comprises for example a screen (not shown) enabling the user of said device 1 to know the value of the voltage of the battery 3. This in particular enables the user to check whether the battery 3 is discharged and whether it requires to be recharged before using said device 1 as charger of a traction battery of a vehicle.

The screen of the voltmeter 19 displaying the voltage value of the battery 3 can also be replaced by one or more light indicators indicating to the user the need to recharge said battery 3 and/or its state of charge.

In the embodiment illustrated on this FIG. 1, the device 1 also includes:
a first switch 15 configured to establish or interrupt the circulation of a current between the first socket 9 and the first converter 5, said first switch is therefore configured to enable or prevent the charging of the battery 3 (for example via a charging terminal connected to the first socket 9);
a second switch 17 configured to establish or interrupt the circulation of a current between the second converter 7 and the second socket 11, said second switch 17 is therefore configured to enable or prevent the charging of a traction battery by the battery 3 (or the discharging of the battery 3).

The first switch 15 comprises a relay K₁ and three switches S₁, S₂, S_{K1}. More particularly, the first switch 15 comprises a switch S_{K1} controlling the relay K₁ and two switches S₁ and S₂ disposed respectively on the cables connecting the first socket 9 to the first converter 5.

The second switch 17 for its part comprises a relay K₂ and four switches S₃, S₄, S₅ et S_{K2}. More particularly, the second switch 17 comprises a switch S_{K2} controlling the relay K₂, two switches S₃, S₄ disposed respectively on the connections connecting the second converter 7 to the second socket 11, and a switch S₅ disposed on the connection between the input of the third converter 13 and the battery 3.

It should be noted that, optionally, and as illustrated in this embodiment, the first and second switches 15 and 17 comprise emergency stop switches, respectively referenced B₁ and B₂, controlled by an emergency stop button (not shown) and configured to interrupt the current circulating respectively from the first socket 9 to the first converter 5 and from the second converter 7 to the second socket 11.

This device 1 furthermore comprises here a human-machine interface 21 (or user interface) making it possible, among other things, to start the device 1, and enabling the user to select the operating mode in which the device 1 is to be used. The interface 21 can thus make it possible to select an operating mode from at least three possible operating modes: a first so-called “standby” operating mode, a second operating mode corresponding to the charging of the battery 3 of the device 1, and a third operating mode corresponding to the charging of a battery of a motor vehicle to be towed.

It should be noted that human-machine interface means all the elements enabling the user to interact with the device 1, and more particularly to control the device 1 and to exchange information with it.

The human-machine interface 21 comprises for example one or more of the following elements: button(s), keypad, screen, touch screen, knob(s), light indicators, etc.

The present operating modes are mutually exclusive. In addition the first operating mode is the default operating mode when said device 1 is started up.

Thus the device 1 is for example started by activating a button of the interface 21 that closes the switch S_{BMS} supplying the third converter 13. Closing said switch S_{BM}S electrically supplies the control system 3a, thus activating the latter. The switch S_{BMS} is for example under time delay, i.e. configured to open again at the end of a predetermined time, in particular when the control system 3a no longer needs to be supplied by the connector of the output 3b, but because it is directly supplied by the battery 3, in particular by the DC voltage U_{D} (output voltage of the battery 3).

The first and second switches 15 and 17 are also controlled by the human-machine interface 21. Thus, after having started the device 1, in standby position, the switches S₁ to S₅ are open, thus preventing the circulation of a current from or in the direction of the battery 3.

Then, when the device 1 passes from any operating mode to the second operating mode, the switch S_{K1} of the relay K₁ closes. The relay K₁ then demands the closing of the switches S₁ and S₂, which thus enables a recharging current to circulate from the first socket 9 to the battery 3. While the switches S₃, S₄, S₅ and S_{K2} of the second relay K₂ are controlled so as to open (or remain open).

In addition, when the device 1 passes from any operating mode to the third operating mode, the switch S_{K2} of the relay K₂ closes. The relay K₂ then controls the closing of the switches S₃, S₄, S₅ and S_{K2}, which thus enables a recharging current to circulate from the second converter 7 to the second socket 11. While the switches S₃, S₄, S₅ and S_{K2} of the second relay K₂ are controlled so as to open (or remain open).

It is thus found that it is not possible to charge the battery 3 and to use it at the same time to charge a traction battery of a motor vehicle. The second and third operating modes are therefore mutually exclusive.

FIG. 2 for its part is a schematic representation of a variant embodiment of the device of FIG. 1. The identical or similar elements thus bear the same references on FIGS. 1 and 2 and will therefore not be detailed again.

Thus, unlike the embodiment in FIG. 1, said mobile device 1′ for recharging a traction battery of a motor vehicle comprises an energy storage element 23, such as a cell, a rechargeable battery and/or a supercapacitor, or any combination of one or more of these elements. Moreover, the device 1′ lacks, at the battery 3, a permanent electrical outlet intended to supply the control system 3a.

Said storage element 23 is thus connected, in particular by a switch S′_{BMS}, to the control system 3a and is configured to electrically supply said system 3a.

Said storage element 23 is also connected to the battery 3 and to the third converter 13.

Said switch S′_{BMS} is thus configured to trigger or interrupt the electrical supply of the control system 3a by said element 23. More particularly, the switch S′_{BMS} configured to supply said system 3a when the device 1′ starts up, until the system 3a is supplied by the battery 3, through the third converter 13 (thus the switch S′_{BMS} is configured to close when the system 3a is supplied by the battery 3, in particular through the third converter 13, said switch S′_{BMS} can also be under time delay).

In addition, said device 1′ comprises a control circuit 23a configured to regulate the charging and/or discharging of said storage element 23, in particular during the recharging of the element 23 by the battery 3 or when there is an electrical supply to said system 3a.

It should moreover be noted that the operating modes described above apply to the device 1′ of FIG. 2′, with the only difference that the start-up of the device 1′ causes the closure of the switch S′_{BMS} that allows the supply of the control system 3a by the storage element 23. Furthermore, as before, the device 1′ comprises a plurality of diodes (not referenced) preventing circulation of the current in some directions (and damage thereof), in particular for the second and third converters 5 and 13 and/or for the element 23.

FIG. 3a for its part is a schematic representation of a second embodiment of the charging device according to the invention. The identical or similar elements thus bear the same references on FIGS. 1 to 3 and will therefore not be detailed again.

Said device 1″, in addition to the previous embodiments and variants illustrated in FIGS. 1 and 2, comprises:
thermal regulation means 24 and 25 configured to heat and/or cool the battery 3;
an external electrical input 3c configured to electrically supply the control system 3a.

Regulating the temperature of the battery 3 during charging and/or discharging thereof affords in particular better control of the capacity and the performances of said battery 3 and also makes it possible not to degrade the state thereof.

More particularly, the thermal regulation means comprise heating means 24 and cooling means 25. These means 24 and 25 are disposed between the second converter 7 and the second switch 17, i.e. they are electrically supplied by the output of the second converter 7. However, in a variant embodiment not shown, said regulation means comprise an electrical supply source independent of and/or distinct from the output of the second converter.

The heating means 24 thus comprises a heating module 33 and a thermal switch TH₁ for cutting off the electrical supply to said heating module 33.

It should be noted that a thermal switch comprises one or more on-off switches that open and close according to the temperature. In the present case, said thermal switch TH1 is configured to be closed (i.e. to allow electrical supply to said heating module 33 and therefore triggering thereof) for a threshold temperature T₁, for example below 7° C., and preferably below 5° C., and open in the contrary case (i.e. the heating module 33 is not supplied and therefore does not operate).

The heating module 33 for its part comprises an electric radiator 35 and a ventilation means V₁. The electric radiator 35 is for example a resistive element that transforms an electric current into heat, while the ventilation means V₁, such as a fan or a motorised fan unit, blows air through the electric radiator 35 in order to be heated. The airflow thus heated is next directed to the battery 3 to be heated.

The cooling means 25 comprises a ventilation means V₂ and a thermal switch TH₂ that regulates the electrical supply to said ventilation means V₂ according to the temperature. More particularly, the thermal switch TH₂ is configured to be closed (i.e. to allow electrical supply to said ventilation means V₂ and therefore triggering thereof) for a threshold temperature T₂, for example above 25° C., and preferably above 30° C., and open in the contrary case (i.e. the ventilation means V₂ is not supplied with electricity and therefore does not operate).

It should be noted that the threshold temperatures T₁ and T₂ correspond directly or indirectly to the temperature of the battery 3, directly when there is a direct measurement of the temperature of the battery 3, and indirectly when there is a remote measurement of the temperature, for example in the device or in proximity to the battery, this measurement making it possible to extrapolate the temperature of the battery.

The device 1″ moreover comprises a relay K₃ disposed at the heating means 24, for example between the thermal switch TH₁ and the heating module 33. The relay K₃ controls and comprises two switches S₆ and S₇ and is itself controlled by the thermal switch TH₁. More particularly, the switch S₆ is disposed at the first switch 15, while the switch S₇ is disposed at the second switch 17.

This is because, as soon as the temperature exceeds the threshold temperature T₁, the relay K₃ triggers and closes the switches S₆ and S₆. The closure of the switches S₆ and S₇ thus contributes to the circulation of current respectively in the first switch 15 and the second switch 17. It should be noted that the relay K₃ and the switches Sᵣ and S₇ that it controls are more particularly illustrated in FIG. 3b.

Thus, at the first switch 15, the switch S₆ is for example disposed between the switch SK₁ and the relay K₁, and thus makes it possible to control the activation of the relay K₁ (in cooperation with the switch SK₁, more particularly when the latter is also closed) and, because of this, to trigger the closure or opening of the first and second switches S₁ and S₂ with the same effects and consequences as described before).

At the second switch 17, the switch S₇ is for example disposed in series with the switch SK₂, and thus makes it possible to control the activation of the relay K₂ (in cooperation with the switch SK₂, more particularly when the latter is also closed) and thus trigger the closure or opening of the third and fourth switches S₃ and S₄ (with the same effects and consequences as described before).

Moreover, in addition to the positions previously described, the switches SK₁ and SK₂ are also disposed on an arm situated between the third converter 13 and the switch S_{BMS}, in parallel with each other.

The switches SK₁ and SK₂, in addition to controlling (as in the other embodiments described) respectively the relays K₁ and K₂, also manage the electrical supply to the third converter 13. The switches SK₁ and SK₂ thus allow the electrical supply to the third converter 13, and therefore to the control system 3a, in the standby operating mode. Change to another operating mode triggers the switches SK₁ and SK₂ as before, whatever the operating mode, and the third converter 13 is always supplied either by the output 3b, or by the battery 3.

The relay K₃ is therefore configured to close when changing from a standby operating position to a position of charging or discharging the battery 3.

The human-machine interface 21 of the device 1″ also comprises:
A light indicator H₁ disposed upstream of the second switch 17, an indicator H₁ that lights up when an electric current is circulating in the second socket 11, said indicator H₁ indicating that the charging is underway to the user of the device 1″.
A light indicator H₂ disposed at the heating means 24 (for example in parallel to the heating module 33). The light indicator H₂ switches on if an electric current is circulating in said heating means 24, thus informing the user that the heating means 24 is active.
A light indicator H₃ disposed upstream of the first converter 5 (in parallel with the input of the converter 5), and preferably downstream of the second switch 17. The indicator H₃ thus switches on when an electric current is circulating in the arm containing the first converter 5, thus indicating that the battery 3 is being charged.

In addition, the device 1″ may also comprise emergency stop switches, referenced B1, B2 and B3, controlled by at least one emergency stop button and configured to interrupt the current circulating respectively from the first socket 9 to the first converter 5, from the second converter 7 to the second socket 11, and in the direction of the third converter 13 (either coming from the output 3b or coming from the battery 3).

As illustrated in FIG. 4, the device, whatever the embodiment or variant of the invention, comprises for example a carriage 30 provided with wheels 30a, in which the battery 3 and the various elements described previously, such as the electrical converters 5, 7 and 13, are housed.

In the case of the second embodiment, the respective ventilation means V1 and V2 of said thermal regulation means 24 and 25 are configured to suck the air through the bottom of the carriage 30 and then to send this airflow towards the top of the carriage 30, in the direction of the battery 3. Advantageously, the airflow circulates along two opposite faces of the battery 3 before being recirculated onto the converters or discharged to the outside, for example through an opening 30b as illustrated in FIG. 4. Thus the battery can be heated with an airflow that is preferably reused to sweep this same battery. It can also be cooled with an airflow that is preferably discharged to the outside.

In a variant embodiment, not shown, of the second embodiment, the device comprises a temperature sensor, replacing the thermal switches, configured to measure (directly or indirectly) the temperature of the battery and to control said thermal regulation means and/or the relay K₃ according to the temperature of said battery.

The carriage can also comprise one or more supports for winding up electrical connection cables and handles 30c for facilitating gripping of said device according to the invention.

In a variant embodiment that is not shown, the first, second and third converters can be merged in a single one or two converters (merged means that one converter fulfils the functions of two or three converters previously described).

The embodiments described above are examples of a possible use of the device according to the invention in recharging batteries, in particular those mounted in a vehicle, with a view to fixing them.

It should be noted that the device according to the invention may comprise one or more sockets for suitably delivering electrical energy to various types of external apparatuses (tools, welding set, lighting means, etc.).

1. Autonomous electrical-supply device (1), characterised in that said device (1) comprises:
an electric battery (3) including a system (3a) for controlling the batteries of accumulators;
a first electrical converter (5) and a second electrical converter (7);
a first electric socket (9) connected to said battery (3) through the first converter (5);
a second electric socket (11) connected to said battery (3) through the second converter (7);
said battery (3) being configured on the one hand to be charged through the first socket (9) and on the other hand to recharge, through the second socket (11), an external appliance.

2. Device (1) according to the preceding claim, characterised in that it is configured to recharge, through the second socket (11), an electric battery, in particular a traction battery of a motor vehicle.

3. Device (1) according to one of claim 1 or 2, characterised in that the first converter (5) is connected to the system (3a) controlling the batteries of accumulators of said battery (3), said system (3a) for controlling the batteries of accumulators regulating, through said first converter (5), the charging of said battery (3).

4. Device (1) according to any one of the preceding claims, characterised in that it comprises a third converter (13) configured to electrically supply the system (3a) for controlling the batteries of accumulators by means of said battery (3).

5. Device (1) according to any one of the preceding claims, characterised in that it comprises at least one energy storage element configured to electrically supply said control system (3a).

6. Device according to any one of the preceding claims, characterised in that it comprises thermal regulation means (24, 25) configured to regulate the temperature of at least one from the battery (3), the first converter (5), the second converter (7) and/or the third converter (13).

7. Device according to the preceding claim, characterised in that said thermal regulation means comprise heating means (24) and/or cooling means (25).

8. Device according to any one of the preceding claims, characterised in that it comprises a human-machine interface (21).

9. Device according to any one of the preceding claims, characterised in that is comprises: a first switch configured to enable or prevent the charging of the battery (3), and a second switch configured to enable or prevent the charging of a traction battery by the battery (3).

10. Device according to claims 8 and 9, characterised in that said device includes at least two operating modes, mutually exclusive, able to be selected through the human-machine interface (21): a mode for charging said battery (3), and a mode for charging a traction battery.

11. Device according to any one of the preceding claims, characterised in that it comprises a carriage (30) provided with wheels (30a).

12. Motor vehicle, characterised in that it comprises a device (1) according to any one of claims 1 to 10.
